(19) United States
(12) Patent Application Publication
(10) Pub. No.: US 2023/0046476 A1
(43) Pub. Date: Feb. 16, 2023

(54) KEY OPERATION DETECTOR, DETECTION METHOD OF KEY OPERATION DETECTOR, AND KEYBOARD DEVICE

(71) Applicant: YAMAHA CORPORATION, Hamamatsu-shi (JP)

(72) Inventor: Kenichi NISHIDA, Hamamatsu-shi (JP)

(21) Appl. No.: 17/970,016

(22) Filed: Oct. 20, 2022

Related U.S. Application Data
(63) Continuation of application No. PCT/JP2021/017041, filed on Apr. 28, 2021.

(30) Foreign Application Priority Data
May 14, 2020 (JP) 2020-085055

(51) Int. Cl. G10H 1/34

(52) U.S. Cl. CPC G10H 1/344; G10H 2220/275; G10H 2220/221

(57) ABSTRACT

A key operation detector includes a conductive unit provided in a key of a keyboard device, a substrate provided to face the key in a pressing and releasing direction of the key, a signal output unit including a coil, provided on the substrate, and configured to output a signal corresponding to a position of the conductive unit relative to the signal output unit, and a detection unit configured to detect a position of the key in the pressing and releasing direction and a displacement of the key in a front-rear direction based on the signal output from the signal output unit.

### CROSS-REFERENCE TO RELATED APPLICATIONS

This is a continuation of International Application No. PCT/JP2021/017041 filed on Apr. 28, 2021, and claims priority from Japanese Patent Application No. 2020-085055 filed on May 14, 2020, the entire content of which is incorporated herein by reference.

### TECHNICAL FIELD

The present disclosure relates to a key operation detector, a detection method of a key operation, and a keyboard device including the key operation detector.

### BACKGROUND ART

In the related art, there is known a keyboard device in which a resonance circuit including a coil is provided on a key and a substrate as a non-contact sensor, and a position and a speed of the key are detected from a signal output from the resonance circuit of the substrate (PTL 1). In Patent Literature 1, the position and the speed of the key in a pressing and releasing direction can be detected using a signal output unit (resonance circuit) including the coil. However, the key cannot be displaced in a front-rear direction.

On the other hand, Patent Literatures 2 and 3 disclose a keyboard device including a key that can be displaced in the front-rear direction. PTL 2 and 3 can detect a displacement of the key in the front-rear direction.

### CITATION LIST

### Patent Literature

[PTL 1] WO2019/122867A1
[PTL 2] U.S. Pat. No. 7,723,597
[PTL 3] JPS49-004621U

### SUMMARY OF INVENTION

### Technical Problem

However, in PTL 2 and 3, the displacement of the key in the pressing and releasing direction and the displacement of the key in the front-rear direction are detected at different positions. Therefore, the signal output unit needs to be separately provided for displacement detection in the pressing and releasing direction and displacement detection in the front-rear direction.

An object of the present disclosure is to provide a key operation detector capable of detecting not only a position of a key in a pressing and releasing direction but also a displacement of the key in a front-rear direction from an output of the same signal output unit.

### Solution to Problem

According to an aspect of the present disclosure, there is provided a key operation detector. The key operation detector includes a conductive unit provided in a key of a keyboard device, a substrate provided the key in a pressing and releasing direction of the key, a signal output unit including a coil, provided on the substrate, and configured to output a signal corresponding to a position of the conductive unit relative to the signal output unit, and a detection unit configured to detect a position of the key in the pressing and releasing direction and a displacement of the corresponding key in a front-rear direction based on the signal output from the signal output unit.

### Advantageous Effects of Invention

According to an aspect of the present disclosure, not only the position of the key in the pressing and releasing direction but also the displacement of the key in the front-rear direction can be detected from the output of the same signal output unit.

### BRIEF DESCRIPTION OF DRAWINGS

FIG. 1 is a schematic side view of a keyboard device.

FIG. 2 is a schematic view of a main part of an operation detection device.

FIG. 3 is a schematic plan view showing a configuration example of a key-side conductive unit and a sensor unit.

FIG. 4 is an enlarged view of a first conductive unit in a top view.

FIG. 5 is an enlarged view of a first signal output unit in a top view.

FIG. 6 is a circuit diagram of the first conductive unit.

FIG. 7 is a circuit diagram of the first signal output unit.

FIG. 8 is a schematic front view of one key and a sensor unit corresponding thereto.

FIG. 9 is a schematic plan view showing a configuration example of the key-side conductive unit and the sensor unit.

FIG. 10 is a schematic plan view showing a first configuration example of a key-side conductive unit and a sensor unit according to a second embodiment.

FIG. 11 is a schematic plan view showing a second configuration example of the key-side conductive unit and the sensor unit.

FIG. 12 is a schematic front view of one key and a sensor unit corresponding thereto.

FIG. 13 is a schematic front view of the one key and the sensor unit corresponding thereto.

FIG. 14 is a schematic plan view showing a configuration example of a first modification of the key-side conductive unit and the sensor unit.

FIG. 15 is a schematic plan view showing a configuration example of a second modification of the key-side conductive unit and the sensor unit.

### DESCRIPTION OF EMBODIMENTS

Hereinafter, embodiments of the present disclosure will be described with reference to the drawings.

### First Embodiment

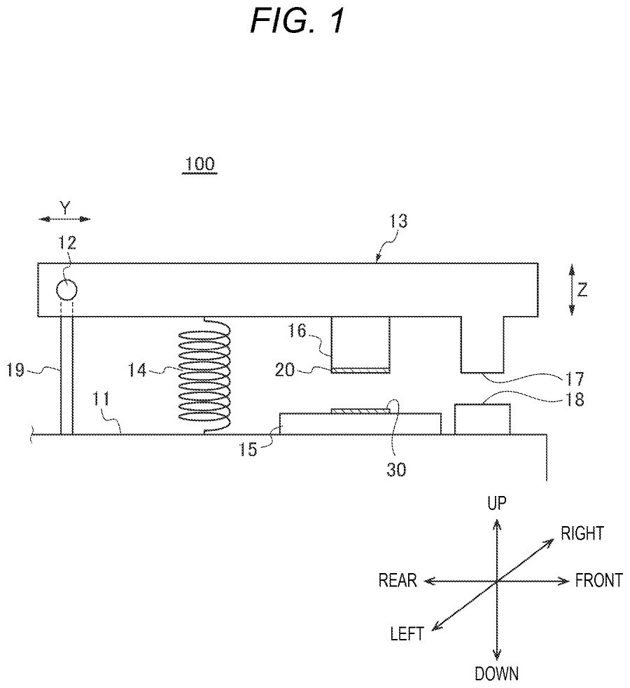

FIG. 1 is a schematic side view of a keyboard device to which a key operation detector of a key operation according to a first embodiment of the present disclosure is applied. FIG. 1 is a view focusing on one key 13 of a plurality of keys 13 in a keyboard device 100. In FIG. 1, a tip end side in a longitudinal direction of the key 13 is a front side, and a key pressing surface (front surface) side is an upper side. A left-right direction is referred to as a direction as viewed from a front surface side of the key 13 on which a player is located. Therefore, a key arrangement direction is the same as the left-right direction. The longitudinal direction of the key 13 is also a front-rear direction. Although the keyboard device 100 is suitable for application to an electronic keyboard instrument, the keyboard device 100 is also suitable as a device that outputs a sound signal without generating sound.

A frame 11 is provided with a plate spring 19. A fulcrum 12 is fixed to an upper end of the plate spring 19. The plate spring 19 can be bent in the front-rear direction (Y direction). In a non-operated state in which the key 13 is not operated, the plate spring 19 stands straight without being bent. As the plate spring 19 is bent, the fulcrum 12 is displaced in the front-rear direction. As the fulcrum 12 is displaced in the front-rear direction, the entire key 13 is also displaced in the front-rear direction. A tip end portion of the key 13 is rotatable in a vertical direction (Z direction) about the fulcrum 12. Therefore, by the operation, the key 13 may be displaced in the front-rear direction and rotated about the fulcrum 12 in parallel.

The key 13 includes a protruding portion 16 and a protruding portion 17. A key-side conductive unit 20, which will be described later, is provided at a lower end of the protruding portion 16. A circuit board 15 is provided on the frame 11. The circuit board 15 is provided to face each key 13 in a pressing and releasing direction of the plurality of keys 13. A sensor unit 30, which will be described later, is disposed on the circuit board 15 to correspond to the key-side conductive unit 20.

A coil spring 14 is attached between the key 13 and the frame 11 in a compressed state. The coil spring 14 always pushes the key 13 upward. A lower limit stopper 18 is provided on the frame 11 to face the protruding portion 17. The key 13 in the non-operated state is restricted to an initial position (non-key-pressed position) shown in FIG. 1 by hitting an upper limit stopper (not shown). When the key 13 is pressed by a player, the coil spring 14 is compressed and the protruding portion 17 hits the lower limit stopper 18. A lower limit position of a key-pressing stroke of the protruding portion 17 is restricted by the lower limit stopper 18. The lower limit stopper 18 is elastically deformable within a predetermined range, and is elastically deformed by being pressed by the protruding portion 17. A position where the lower limit stopper 18 is elastically deformed by a predetermined range is a lowest limit position of the key-pressing stroke of the protruding portion 17. A stopper for defining the lowest limit position may be provided separately from the lower limit stopper 18. When the player releases the key 13 from a key-pressing end state in which the protruding portion 17 pushes the lower limit stopper 18, the key 13 returns to the initial position by a force of the coil spring 14.

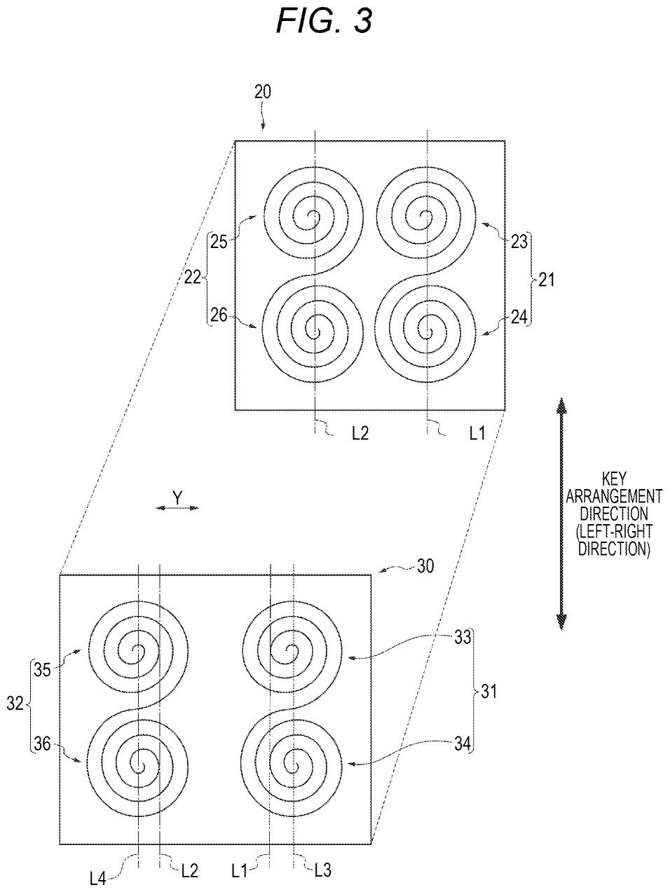

In the key-pressing stroke of the key 13, the key-side conductive unit 20 approaches the sensor unit 30, and in a key-releasing stroke of the key 13, the key-side conductive unit 20 is separated from the sensor unit 30. Here, even when the protruding portion 17 reaches the lowest limit position, the key-side conductive unit 20 does not come into contact with the sensor unit 30. Therefore, the key-side conductive unit 20 is always in a non-contact relationship with the sensor unit 30. Although details will be described later, the key-side conductive unit 20 includes a pair of conductive units 21 and 22 (FIG. 3). The sensor unit 30 includes, for example, two (a pair of) signal output units 31 and 32 as a plurality of signal output units that output a signal according to a distance from the key-side conductive unit 20 of the corresponding key 13 (FIG. 3).

The plurality of keys 13 include a plurality of white keys and a plurality of black keys. The plurality of keys 13 are arranged in the left-right direction (key arrangement direction) as viewed from the player. Configurations of the respective keys 13 and the key-side conductive units 20 and the sensor units 30 corresponding thereto are common. The tip end portion of the key 13 swings in a pitch direction, which is the pressing and releasing direction, by being pressed and released. When the player applies a force forward or rearward with respect to the key 13 while the key 13 is being pressed or in a pressed state, the plate spring 19 is deformed and the key 13 is displaced in the front-rear direction together with the fulcrum 12.

In the related art, after-touch is detected by a further key operation at a key-pressing end stage and used for sound control to expand expression of sound. Typically, as the after-touch, an increase or decrease of the force in the pressing and releasing direction at the key-pressing end stage is detected. However, in addition to the above effect, if the after-touch can be caused by the player intentionally displacing the key in the front-rear direction at the key-pressing end stage, expression power is improved. As will be described in detail later, in the present embodiment, by combining the key-side conductive unit 20 and the sensor unit 30, it is possible to detect not only a stroke position of the key 13 but also the displacement of the key 13 in the front-rear direction in a non-contact manner. In addition, the position and the displacement can be detected not only at the key-pressing end stage but also during key pressing and key release.

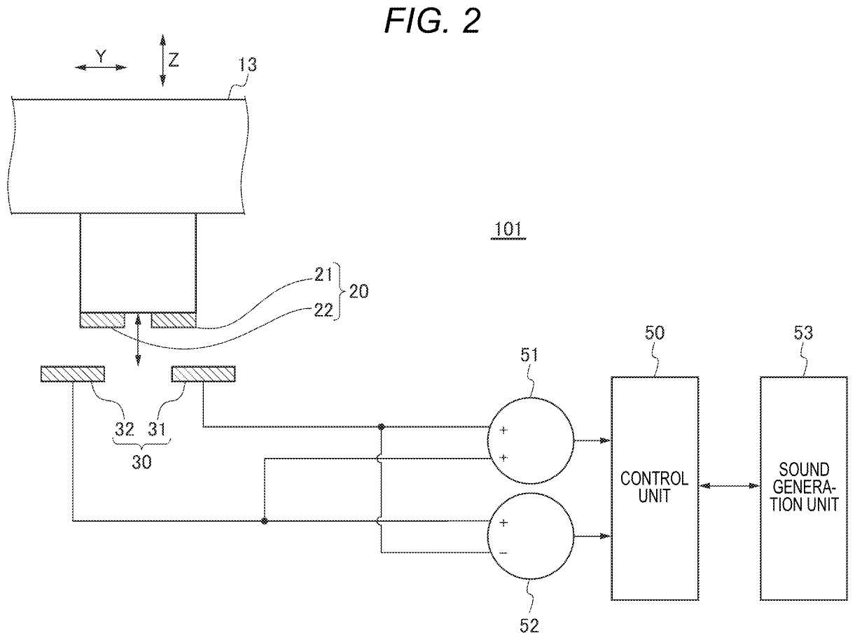

FIG. 2 is a schematic view of a main part of an operation detection device 101. The operation detection device 101 includes an addition unit 51, a subtraction unit 52, and a control unit 50 in addition to the key-side conductive unit 20 and the sensor unit 30. A detection unit in the present disclosure mainly includes the addition unit 51, the subtraction unit 52, and the control unit 50. Although not illustrated, the control unit 50 includes a CPU, a RAM, a ROM, a timer, and the like. A sound generation unit 53 includes a sound source circuit and an effect circuit. The control unit 50 controls sound generation by the sound generation unit 53 based on a detection result of an operation of each key 13 detected by the operation detection device 101. For example, the control unit 50 controls generation and muffling of sound based on the detection result in the pitch direction, and controls an effect of the generated sound based on the detection result related to the displacement in the front-rear direction. Details of effect impartment will be described later.

FIG. 3 is a schematic plan view showing a configuration example of the key-side conductive unit 20 and the sensor unit 30. In FIG. 3, the key-side conductive unit 20 is shown as a projection view in a top view (plan view). A left side of FIG. 3 is the rear of the key 13 including the fulcrum 12. In FIG. 3, illustration of a capacitor and a resistor is omitted. The key-side conductive unit 20 includes the pair of conductive units (the first conductive unit 21 and the second conductive unit 22). The first conductive unit 21 and the second conductive unit 22 are disposed side by side in the front-rear direction. The first conductive unit 21 is a circuit including a coil in which two spiral portions (winding portions 23 and 24) are connected to each other. The second conductive unit 22 is also a circuit including a coil in which two spiral portions (winding portions 25 and 26) are connected to each other.

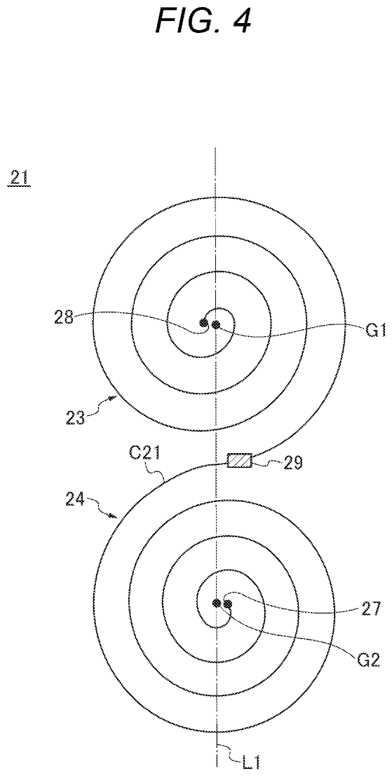

The sensor unit 30 is provided corresponding to each key 13 and includes the pair of signal output units (the first signal output unit 31 and the second signal output unit 32). The first signal output unit 31 and the second signal output unit 32 are disposed side by side in the front-rear direction. The first signal output unit 31 is a circuit including a coil in which two spiral portions are connected to each other. The second signal output unit 32 is also a circuit including a coil in which two spiral portions (winding portions 35 and 36) are connected to each other. Configurations of the first conductive unit 21 and the second conductive unit 22 are common. Configurations of the first signal output unit 31 and the second signal output unit 32 are common. Representatively, detailed configurations of the first conductive unit 21 and the first signal output unit 31 will be described with reference to FIGS. 4 to 7.

FIG. 4 is an enlarged view of the first conductive unit 21 in a top view. The first conductive unit 21 includes an 8-shaped coil C21 as a whole. The coil C21 is disposed in a flat shape at the lower end of the protruding portion 16. The coil C21 is continuous from a via 27 to a via 28 via a capacitor 29. Further, the via 27 and the via 28 are directly connected to each other on a back surface of a substrate. The winding portion 23 and the winding portion 24 are adjacent to each other. Positions of centers of gravity of the winding portions 23 and 24 are referred to as centers of gravity G1 and G2, respectively. The centers of gravity G1 and G2 are defined as the positions of the centers of gravity of figures having substantially circular outer shapes of the winding portions 23 and 24. Alternatively, the centers of gravity G1 and G2 may be defined as the positions of the centers of gravity focusing on masses of the respective winding portions 23 and 24. A straight line L1 passing through the centers of gravity G1 and G2 is substantially parallel to the key arrangement direction. A straight line L2 (FIG. 3) passing through the centers of gravity G1 and G2 of the winding portions 25 and 26 of the second conductive unit 22 is also substantially parallel to the key arrangement direction. Therefore, the first conductive unit 21 and the second conductive unit 22 are disposed such that the straight lines L1 and L2 are substantially parallel to each other.

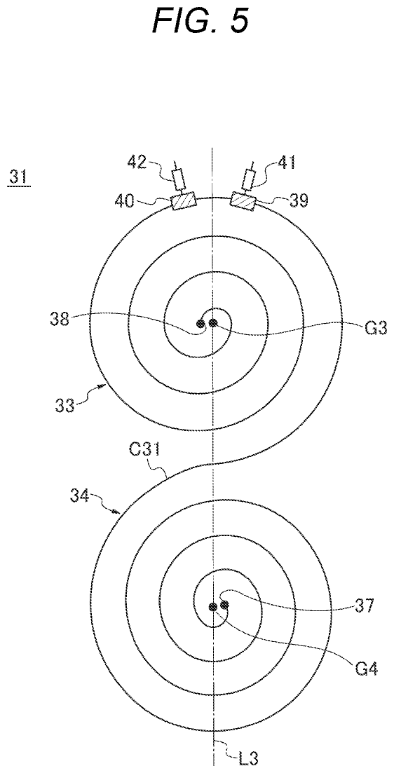

FIG. 5 is an enlarged view of the first signal output unit 31 in a top view. The first signal output unit 31 includes an 8-shaped coil C31 as a whole. The coil C31 is disposed on the circuit board 15 in a flat shape. The coil C31 is continuous from a via 37 to a via 38 via capacitors 39 and 40. Further, the via 37 and the via 38 are directly connected to each other on the back surface of the substrate. A resistor 41 is connected to the capacitor 39, and a resistor 42 is connected to the capacitor 40. It is not essential to provide the resistors 41 and 42. A winding portion 33 and a winding portion 34 are adjacent to each other. Positions of centers of gravity of the winding portions 33 and 34 are referred to as centers of gravity G3 and G4, respectively. Definition of the centers of gravity G3 and G4 is the same as the definition of the centers of gravity G1 and G2. A straight line L3 passing through the centers of gravity G3 and G4 is substantially parallel to the key arrangement direction. A straight line L4 (FIG. 3) passing through the centers of gravity G1 and G2 of the winding portions 35 and 36 of the second signal output unit 32 is also substantially parallel to the key arrangement direction. Therefore, the first signal output unit 31 and the second signal output unit 32 are disposed such that the straight lines L3 and L4 are substantially parallel to each other. As shown in FIG. 3, an interval between the straight lines L3 and L4 is wider than an interval between the straight lines L1 and L2.

As shown in FIG. 4, the winding portions 23 and 24 have the same spiral direction as each other with a center of each of the winding portions 23 and 24 as a base point. That is, the spiral direction of the winding portion 23 when the via 28 close to the center of gravity G1 is regarded as a start point is a clockwise direction. The spiral direction of the winding portion 24 when the via 27 close to the center of gravity G2 is regarded as a start point is also the clockwise direction. From such a relationship, when a current in a certain direction flows through the coil C21, a direction of a magnetic flux in the winding portion 23 and a direction of a magnetic flux in the winding portion 24 are opposite to each other. Similarly, as shown in FIG. 5, the winding portions 33 and 34 have the same spiral direction as each other with a center of each of the winding portions 33 and 34 as a base point. When a current in a certain direction flows through the coil C31, a direction of a magnetic flux in the winding portion 33 and a direction of a magnetic flux in the winding portion 34 are opposite to each other.

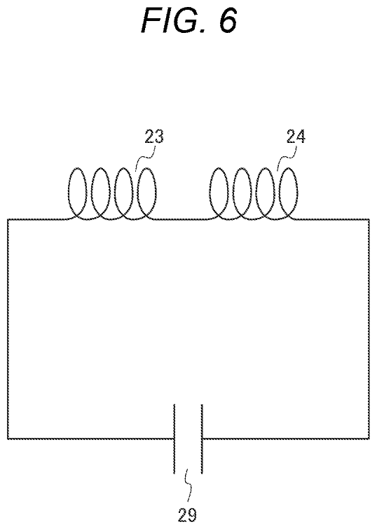

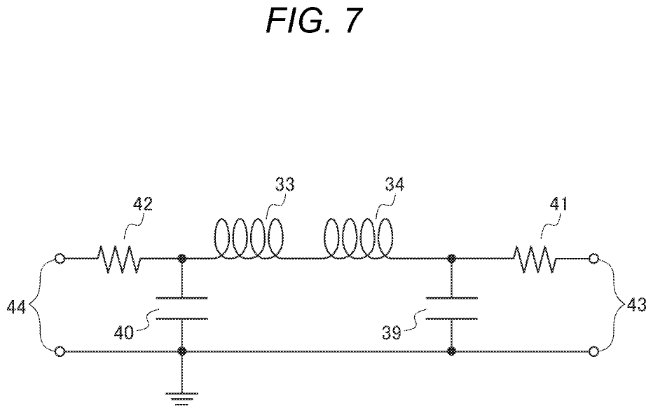

FIG. 6 is a circuit diagram of the first conductive unit 21. FIG. 7 is a circuit diagram of the first signal output unit 31. The first conductive unit 21 is configured as a resonance circuit on a passive side. The first conductive unit 21 is a closed circuit. The first signal output unit 31 is configured as a resonance circuit on an active side. These resonance circuits are basically the same as the configuration disclosed in PTL 1 (WO2019/122867A1).

In the first signal output unit 31, an input-side terminal 44 is connected to a drive circuit (not shown). A detection signal is extracted from an output-side terminal 43. As shown in FIG. 2, a detection signal from the second signal output unit 32 is input to a + terminal of the addition unit 51 and a + terminal of the subtraction unit 52. The detection signal from the first signal output unit 31 is input to the other + terminal of the addition unit 51 and a − terminal of the subtraction unit 52. In order to correct a phase shift between the detection signal from the first signal output unit 31 and the detection signal from the second signal output unit 32, the respective outputs may be input to the addition unit 51 and the subtraction unit 52 via a smoothing circuit (not shown). The addition unit 51 outputs a sum of the detection signals from the first signal output unit 31 and the second signal output unit 32 to the control unit 50. The subtraction unit 52 outputs a difference between the detection signal from the first signal output unit 31 and the detection signal from the second signal output unit 32 to the control unit 50. These detection signals are continuous amounts.

The outputs of the signal output units 31 and 32 are, for example, voltage values. When the first conductive unit 21 approaches the first signal output unit 31 in a state in which the signal output units 31 and 32 are driven at a predetermined resonance frequency, a current flows in a direction in which the magnetic flux generated in the first signal output unit 31 is cancelled in the first conductive unit 21. As a result, the magnetic flux of the first signal output unit 31 changes, and the voltage changes. Therefore, the detection signal can be extracted as a voltage value. The output of the first signal output unit 31 decreases as the first conductive unit 21 approaches the first signal output unit 31. Similarly, when the second conductive unit 22 approaches the second signal output unit 32, the output of the second signal output unit 32 decreases accordingly. That is, the outputs (voltages) of the signal output units 31 and 32 change according to distances to the corresponding conductive units 21 and 22, and the outputs become smaller as the distances become shorter. A change in a resonance signal or a current value may be adopted as the outputs of the signal output units 31 and 32.

In particular, as described above, both the coil C21 and the coil C31 have an 8-shape. Therefore, the relationship between the first signal output unit 31 and the first conductive unit 21 is as follows. First, it is assumed that, in a state where an upward magnetic flux is generated from the winding portion 33 of the first signal output unit 31 and a downward magnetic flux is generated from the winding portion 34, the first conductive unit 21 approaches the first signal output unit 31. Then, a current in a direction in which the upward magnetic flux from the winding portion 33 is cancelled flows in the winding portion 23 of the first conductive unit 21. As a result, the upward magnetic flux is generated in the winding portion 24 of the first conductive unit 21, and therefore, the downward magnetic flux of the winding portion 34 of the first signal output unit 31 is weakened. Therefore, the change in the output of the first signal output unit 31 is larger than that in a configuration in which a winding direction of the winding portion 33 and a winding direction of the winding portion 34 are opposite to each other. As a result, sensitivity as a sensor is increased.

From a viewpoint of preventing crosstalk, the first signal output unit 31 and the second signal output unit 32 may have different resonance frequencies. In addition, as disclosed in PTL 1 (WO2019/122867A1), the plurality of sensor units 30 may have different resonance frequencies. In particular, the sensor units 30 corresponding to the adjacent keys 13 may have different resonance frequencies. In addition, as disclosed in PTL 1 (WO2019/122867A1) and Japanese Patent No. 4375302, when each sensor unit 30 is driven, time division processing may be executed using a multiplexer and a demultiplexer. For example, the plurality of sensor units 30 are grouped in a key region such that physically adjacent sensor units 30 are not simultaneously driven. For example, the sensor units 30 may be simultaneously driven one by one in each group in order from a low frequency sensor unit 30 in each group.

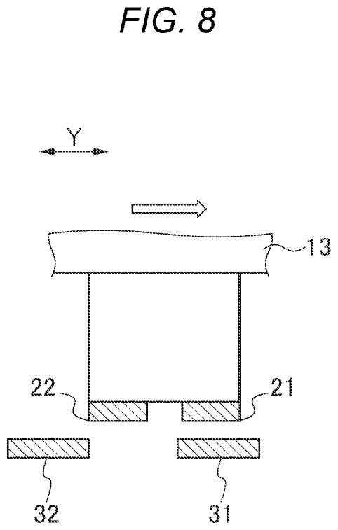

FIG. 8 is a schematic front view of one key 13 and the sensor unit 30 corresponding thereto. The stroke position of the key 13 (the position in the pressing and releasing direction) and the displacement of the key 13 in the front-rear direction are detected as follows.

First, when the key-side conductive unit 20 approaches the sensor unit 30 by a key pressing operation, as shown in FIG. 2, the detection signals of the signal output units 31 and 32 are input to the addition unit 51 and the subtraction unit 52. The control unit 50 detects the stroke position of the key 13 based on the sum of the detection signals of the signal output units 31 and 32 received from the addition unit 51. At this time, for example, as the sum is smaller, the stroke position is detected as a deeper position.

In parallel with this, the control unit 50 detects a magnitude of the displacement of the key 13 in the front-rear direction based on the difference between the detection signals of the signal output units 31 and 32 received from the subtraction unit 52. At this time, as the difference is larger, the displacement of the key 13 in the front-rear direction is detected as a large value. As shown in FIG. 8, when the key 13 receives a forward force while being pressed, the key 13 is displaced forward. In this case, an overlapping area between the first conductive unit 21 and the first signal output unit 31 is larger than an overlapping area between the second conductive unit 22 and the second signal output unit 32. Therefore, since the first signal output unit 31 outputs the detection signal smaller than that of the second signal output unit 32, the difference between the detection signals is large.

As described above, as shown in FIG. 3, the interval between the straight lines L3 and L4 is wider than the interval between the straight lines L1 and L2. That is, the first signal output unit 31 is disposed to be shifted to a front side with respect to the first conductive unit 21, and the second signal output unit 32 is disposed to be shifted to a rear side (direction opposite to the first signal output unit 31) with respect to the second conductive unit 22. For example, as shown in FIG. 8, a case where the key 13 receives a forward force and the key 13 is displaced forward in a horizontal direction is considered. In this case, the overlapping area between the first conductive unit 21 and the first signal output unit 31 is larger than the overlapping area between the second conductive unit 22 and the second signal output unit 32 in terms of projection in a plan view. Therefore, the magnetic flux caused by the first conductive unit 21 acting on the first signal output unit 31 is stronger than the magnetic flux caused by the second conductive unit 22 acting on the second signal output unit 32. Then, since the first signal output unit 31 outputs the detection signal smaller than that of the second signal output unit 32, the difference between the detection signals is large. As a result, the control unit 50 can detect forward displacement of the key 13 and the magnitude of the forward displacement of the key 13. When the key 13 is displaced rearward, the difference between the detection signals is inverted.

Due to such a shift arrangement, since the difference between the detection signals of the signal output units 31 and 32 when the key 13 is displaced in the front-rear direction is large, the sensitivity of detection in the front-rear direction is increased. The control unit 50 controls an effect of the sound based on the detected displacement in the front-rear direction.

The direction of the shift may be opposite to the illustrated direction. In addition, the shift arrangement is not essential, the interval between the straight lines L1 and L2 and the interval between the straight lines L3 and L4 may be the same, and the straight lines L1 and L2 and the straight lines L3 and L4 may overlap each other. In this case, from the viewpoint of preventing crosstalk, it is desirable to dispose the key-side conductive unit 20 and the sensor unit 30 such that the center of gravity G1 and the center of gravity G3 coincide with each other, and the center of gravity G2 and the center of gravity G4 coincide with each other.

The control unit 50 detects the stroke position of the key 13 at any time during key pressing or key release. When the stroke position of the key 13 becomes deeper than a first predetermined position, the control unit 50 generates a note-on event, and causes the sound generation unit 53 to start sound generation. After the start of the sound generation, the control unit 50 performs after-control for imparting an effect such as vibrato based on the magnitude of the detected displacement in the front-rear direction. For example, the control unit 50 increases a degree of the imparted effect or shortens a cycle as the displacement in the front-rear direction is large. The detection result may be used for the control of the effect impartment not only at the key-pressing end stage of the key 13 but also during key pressing or key release.

In addition, when the stroke position of the key 13 is shallower than a second predetermined position (shallower than the first predetermined position) during the sound generation, the control unit 50 causes the sound generation unit 53 to start muffling. The control unit 50 may detect a key pressing speed based on a time required for the key 13 to reach the first predetermined position from a third predetermined position (shallower than the first predetermined position), and use the detected key pressing speed for the sound control such as a sound volume. Similarly, a key release speed may be detected during the key release operation and used for the sound control. An effect parameter to be controlled is not limited.

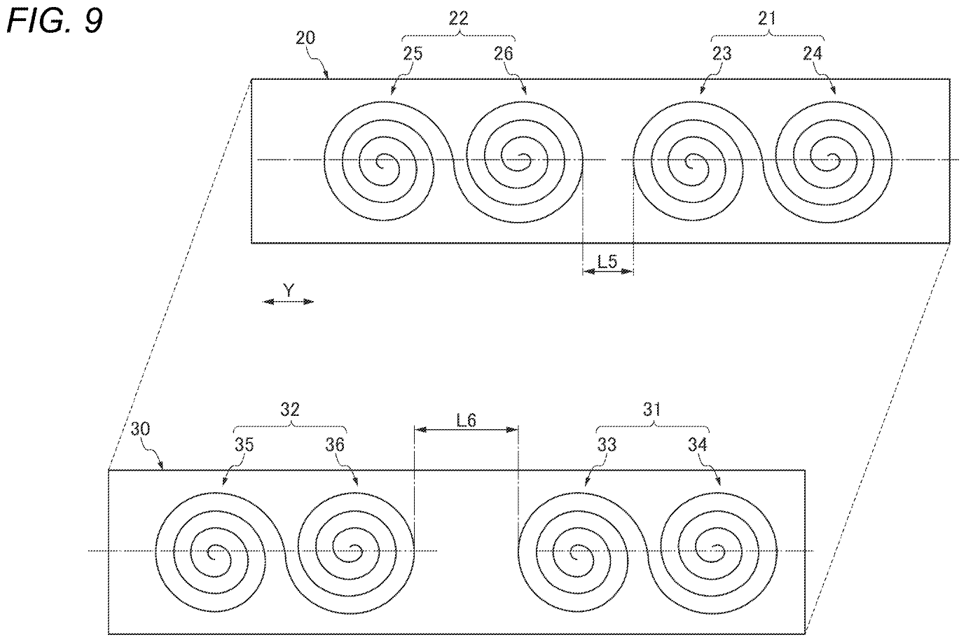

Although the arrangement shown in FIG. 3 described above may be applied to either the white key or the black key, it is difficult to implement the arrangement with a narrow key width. The arrangement shown in FIG. 3 is suitable for the white key. An arrangement suitable for the black key with a narrow key width will be described with reference to FIG. 9.

FIG. 9 is a schematic plan view showing a configuration example of the key-side conductive unit 20 and the sensor unit 30. In FIG. 9, the key-side conductive unit 20 is shown as a projection view in a top view. In FIG. 9, illustration of the capacitor and the resistor is omitted. The configuration of each of the first conductive unit 21, the second conductive unit 22, the first signal output unit 31, and the second signal output unit 32 is the same as the configuration described in FIG. 3.

As shown in FIG. 9, the conductive units 21 and 22 are disposed on a straight line side by side in a key longitudinal direction (front-rear direction). The signal output units 31 and 32 are also disposed side by side in the key longitudinal direction. In the front-rear direction (Y direction), the conductive units 22 and 32 are closer to the fulcrum 12 than the conductive units 21 and 31. On the other hand, an interval L6 between the first signal output unit 31 and the second signal output unit 32 is larger than an interval L5 between the first conductive unit 21 and the second conductive unit 22 in the front-rear direction. That is, the first signal output unit 31 is disposed to be shifted to the front side with respect to the first conductive unit 21, and the second signal output unit 32 is disposed to be shifted to the rear side with respect to the second conductive unit 22. The intervals L5 and L6 may be defined as the interval between the centers of gravity of the respective conductive units and the interval between the centers of gravity of the respective signal output units. The arrangement shown in FIG. 9 may also be adopted in the white key.

According to the present embodiment, the key-side conductive unit 20 is provided as the pair of conductive units in each of the plurality of keys 13. The sensor unit 30 (the pair of signal output units 31 and 32) corresponding to each key 13 is provided on the circuit board 15. The sensor unit 30 outputs a signal corresponding to the distance from the key-side conductive unit 20 of the corresponding key 13. The control unit 50 acquires the signal output from the sensor unit 30, and detects the position of the corresponding key 13 in the pressing and releasing direction and the displacement of the corresponding key 13 in the front-rear direction based on the acquired signal. For example, the control unit 50 detects the stroke of the key 13 based on the sum of the signals respectively output from the signal output units 31 and 32, and detects the displacement of the key 13 in the front-rear direction based on the difference between the signals respectively output from the signal output units 31 and 32. Therefore, not only the position of the key 13 in the pressing and releasing direction but also the displacement of the key 13 in the front-rear direction can be detected from the outputs of the same (common) signal output units 31 and 32.

In particular, the displacement of the key 13 in the front-rear direction can be accurately detected by the shift arrangement shown in FIGS. 3 and 9.

Further, in each of the key-side conductive unit 20 and the sensor unit 30, the two spiral portions adjacent to each other have the same spiral direction as each other with a center of each of the two spiral portions as a base point, so that the crosstalk can be prevented.

It is not essential to use the sum of the signals for the detection of the stroke position, and the stroke position may be detected based on only any one of the pair of signal output units 31 and 32.

### Second Embodiment

In the first embodiment, the position of the key 13 in the pressing and releasing direction and the displacement of the key 13 in the front-rear direction are detected based on the signal output from the sensor unit 30. In a second embodiment of the present disclosure, in addition to the above, the displacement of the key 13 in a yaw direction or a roll direction is also detectable.

First, the key 13 is mainly displaced in the pitch direction, but strictly speaking, is also displaced in the yaw direction and the roll direction. That is, the key 13 can be displaced also in the yaw direction by receiving a force in the left-right direction. Further, the key 13 can be displaced in a direction (roll direction) in which the key 13 rotates around an axis along the longitudinal direction by the key 13 receiving the force in the left-right direction or being pressed in the vicinity of an end position in a width direction. The key 13 is mainly displaced in the pitch direction, but as disclosed in Japanese Patent No. 4375302 and the like, a structure of the key 13 may be a structure that is displaced in the roll direction and the yaw direction by design.

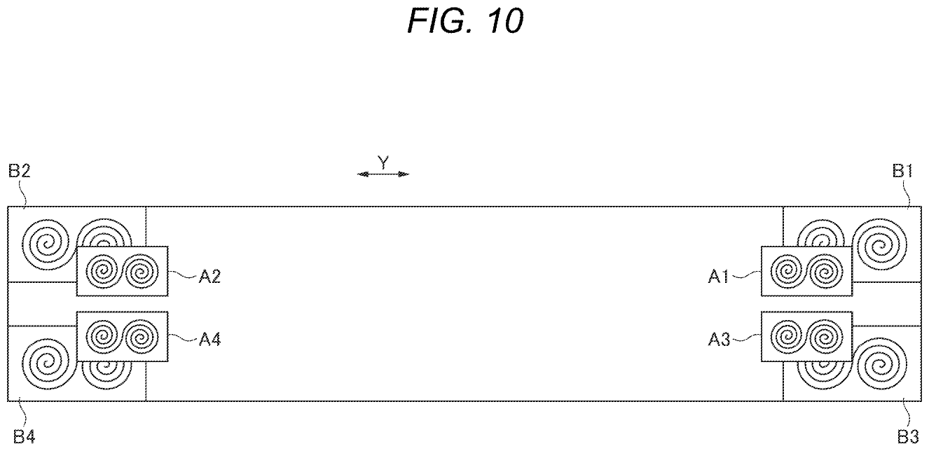

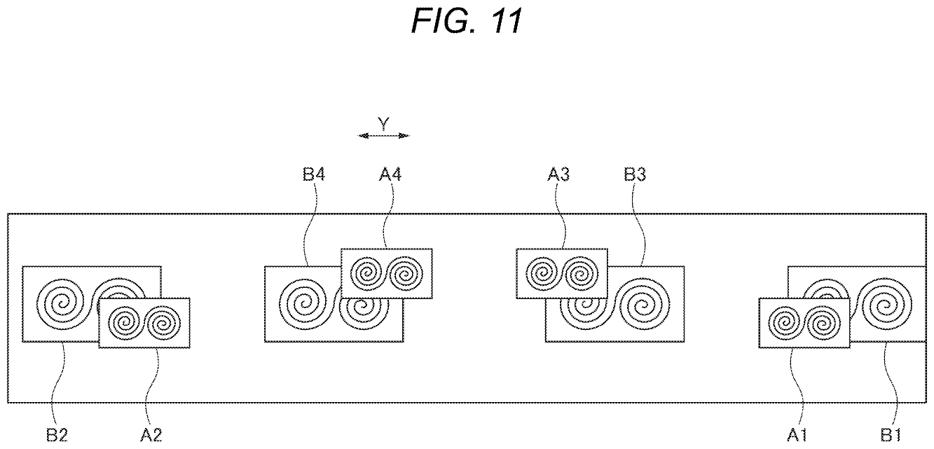

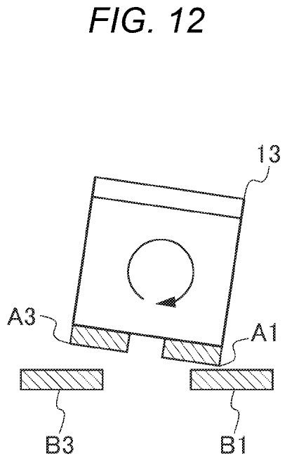

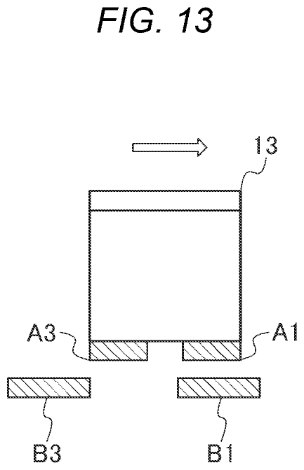

FIGS. 10 and 11 are schematic plan views showing a first configuration example and a second configuration example of the key-side conductive unit 20 and the sensor unit 30 according to the second embodiment. FIGS. 12 and 13 are schematic front views of one key 13 and the sensor unit 30 corresponding thereto in the first configuration example.

In FIGS. 10 to 13, conductive units A1 and A2 are configured similarly to the conductive units 21 and 22 shown in FIG. 9. Conductive units A3 and A4 are also configured similarly to the conductive units 21 and 22 shown in FIG. 9. Signal output units B1 and B2 are configured similarly to the signal output units 31 and 32 shown in FIG. 9. Signal output units B3 and B4 are also configured similarly to the signal output units 31 and 32 shown in FIG. 9. In FIGS. 10 and 11, the conductive units A1 to A4 are shown as projection views in a top view (plan view). In any of the first and second configuration examples, the conductive unit A2 and the signal output unit B2 are closer to the fulcrum 12 in the front-rear direction (Y direction) than the conductive unit A1 and the signal output unit B1.

In the first and second configuration examples (FIGS. 10 and 11), the conductive units A1 to A4 are shifted in both the front-rear direction and the key arrangement direction with respect to the signal output units B1 to B4. In the first configuration example (FIG. 10), in the key arrangement direction, an interval between the signal output portions B1 and B3 is larger than an interval between the conductive units A1 and A3, and an interval between the signal output units B2 and B4 is larger than an interval between the conductive units A2 and A4. In the front-rear direction, an interval between the signal output portions B1 and B2 is larger than an interval between the conductive units A1 and A2, and an interval between the signal output units B3 and B4 is larger than an interval between the conductive units A3 and A4.

In the second configuration example (FIG. 11), the signal output units B1 to B4 are arranged on a straight line in the front-rear direction. In the key arrangement direction, the conductive units A1 and A3 are shifted to opposite sides with the signal output units B1 and B3 interposed, and the conductive units A2 and A4 are shifted to opposite sides with the signal output units B2 and B4 interposed. In the front-rear direction, the interval between the signal output units B1 and B2 is larger than the interval between the conductive units A1 and A2, and the interval between the signal output units B3 and B4 is larger than the interval between the conductive units A3 and A4.

A method of detecting the stroke position of the key 13, the displacement in the front-rear direction, and lateral swing (displacement in the yaw direction or the roll direction) will be described with reference to the first configuration example (FIG. 10) as an example.

First, for the detection of the stroke position of the key 13 and the displacement of the key 13 in the front-rear direction, a combination of “the conductive unit A1 and the signal output unit B1” and “the conductive unit A2 and the signal output unit B2” is used. That is, the control unit 50 detects the stroke position of the key 13 based on the sum of the detection signals of the signal output units B1 and B2. In addition, the control unit 50 detects the magnitude of the displacement of the key 13 in the front-rear direction based on the difference between the detection signals of the signal output units B1 and B2. For the detection of the stroke position of the key 13 and the displacement of the key 13 in the front-rear direction, a combination of “the conductive unit A3 and the signal output unit B3” and “the conductive unit A4 and the signal output unit B4” may be used.

Next, for the detection of the lateral swing, a combination of “the conductive unit A1 and the signal output unit B1” and “the conductive unit A3 and the signal output unit B3” is used. That is, the control unit 50 detects the magnitude of the lateral swing of the key 13 based on the difference between the detection signals of the signal output units B1 and B3 received from the subtraction unit 52. At this time, as the difference is large, the lateral swing is detected as a large value. When the signal output units B1 and B2 are the pair of signal output units for detecting the stroke position and the displacement in the front-rear direction, the signal output units B1 and B3 correspond to another pair of signal output units for detecting the lateral swing.

As shown in FIG. 12, when a right portion of the key pressing surface of the key 13 is pressed, the key 13 rolls rightward. In this case, a distance between the conductive unit A1 and the signal output unit B1 is shorter than a distance between the conductive unit A3 and the signal output unit B3. Therefore, since the signal output unit B1 outputs the detection signal smaller than that of the signal output unit B3, the difference between the detection signals is large. As a result, the control unit 50 can detect the roll direction and the magnitude of roll displacement of the key 13.

As described above, the interval between the signal output units B1 and B3 is wider than the interval between the conductive units A1 and A3. As shown in FIG. 13, when the key 13 receives a rightward force, the key 13 is displaced rightward in the horizontal direction. In this case, an overlapping area between the conductive unit A1 and the signal output unit B1 is larger than an overlapping area between the conductive unit A3 and the signal output unit B3 in terms of projection in a plan view. Therefore, the magnetic flux caused by the conductive unit A1 acting on the signal output unit B1 is stronger than the magnetic flux caused by the conductive unit A3 acting on the signal output unit B3. Then, since the signal output unit B1 outputs the detection signal smaller than that of the signal output unit B2, the difference between the detection signals is large. As a result, the control unit 50 can detect the magnitude of the displacement of the key 13 in the yaw direction. Due to such a shift arrangement, since the difference between the detection signals of the signal output units B1 and B3 when the key 13 is displaced in the horizontal direction is large, the sensitivity of the detection in the yaw direction is increased.

The displacements in the yaw direction and the roll direction (so-called lateral swing) are compositely generated, and it is difficult for the player to perform the performance while being conscious of the displacements in both the yaw direction and the roll direction, so that there is no great significance in distinguishing between the two in detection. Therefore, the control unit 50 may compositely capture the displacements in both the yaw direction and the roll direction and detect the displacements as the lateral swing, which may be useful for effect control. In addition, the lateral swing may be detected not only at the key-pressing end stage but also during key pressing or key release.

When the lateral swing is detected, it may be determined whether the lateral swing is mainly caused by the roll displacement or yaw displacement, from a difference between the difference between the signal output units B1 and B3 and the difference between the signal output units B2 and B4. For example, in the key arrangement direction, since a tip end of the key is displaced more largely than a rear end of the key, if the difference is large, it can be determined that the lateral swing is mainly caused by the yaw displacement. For the detection of the lateral swing, a combination of “the conductive unit A2 and the signal output unit B2” and “the conductive unit A4 and the signal output unit B4” may be used.

Even when the second configuration example (FIG. 11) is adopted, the stroke position of the key 13, the displacement in the front-rear direction, and the lateral swing can be detected. For example, for the detection of the stroke position of the key 13 and the displacement in the front-rear direction, the combination of “the conductive unit A1 and the signal output unit B1” and “the conductive unit A2 and the signal output unit B2” is used.

Alternatively, a combination of “the conductive unit A3 and the signal output unit B3” and “the conductive unit A4 and the signal output unit B4” may be used. For the detection of the lateral swing, the combination of “the conductive unit A1 and the signal output unit B1” and “the conductive unit A3 and the signal output unit B3” is used. Alternatively, the combination of “the conductive unit A2 and the signal output unit B2” and “the conductive unit A4 and the signal output unit B4” may be used.

According to the present embodiment, the same effects as those of the first embodiment can be achieved by detecting not only the position of the key 13 in the pressing and releasing direction but also the displacement of the key 13 in the front-rear direction from the output of the same (common) signal output unit. In addition, the displacement of the key in the yaw direction or the roll direction can be detected from the output of the same (common) signal output unit even during key pressing.

In any of the first configuration example (FIG. 10) and the second configuration example (FIG. 11), the two spiral portions of each of the conductive units A1 to A4 and the signal output units B1 to B4 are disposed side by side in the front-rear direction. However, the two spiral portions of each of the conductive units A1 to A4 and the signal output units B1 to B4 may be disposed side by side in the key arrangement direction.

In the present embodiment, the detection of the stroke position, the detection of the displacement in the front-rear direction and the lateral swing can share the sensor unit to be used, so that the configuration is simple and there is no need to provide an optical sensor. However, in order to detect the stroke position and the key pressing speed, an optical or contact-type position sensor or speed sensor may be separately provided. It is not essential to detect the stroke position from the pair of signal output units.

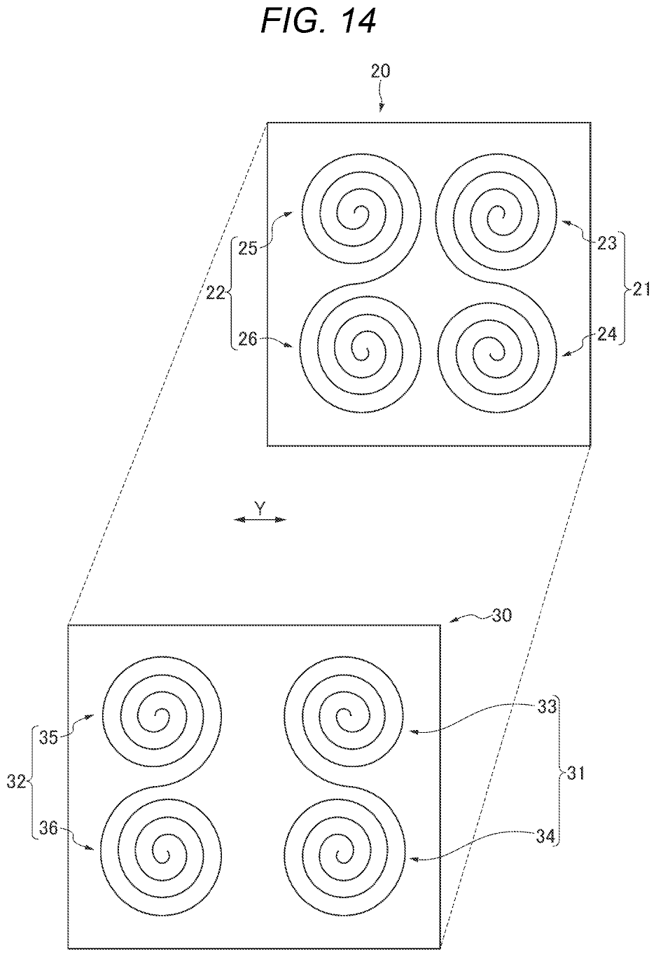

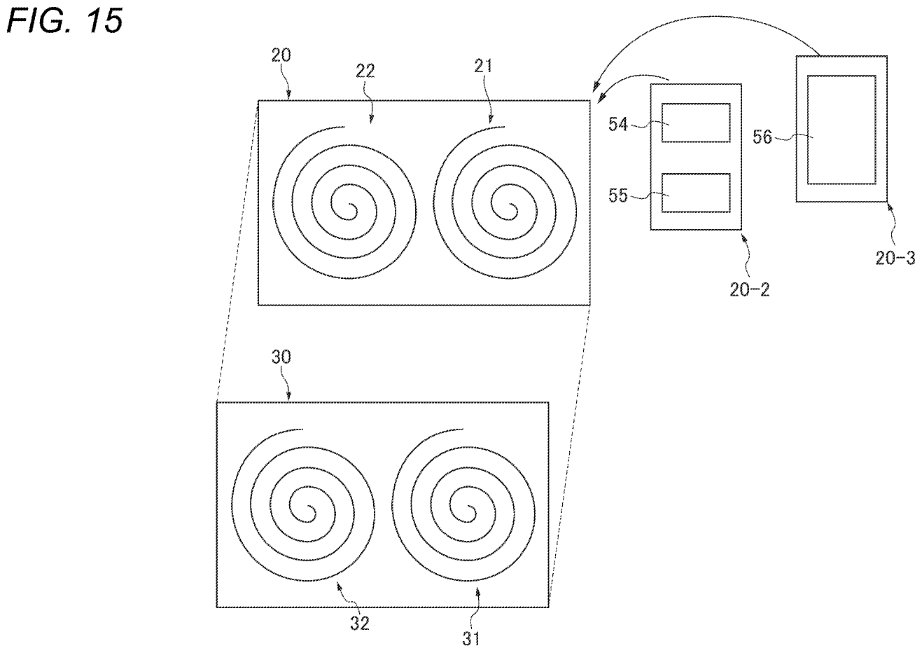

Hereinafter, modifications in the above respective embodiments will be described with reference to FIGS. 14 and 15. FIG. 14 is a schematic plan view showing a configuration example of a first modification of the key-side conductive unit 20 and the sensor unit 30. In the example shown in FIG. 14, the winding directions of the winding portions 23 and 24 of the first conductive unit 21 are opposite to those in the example of FIG. 3. Therefore, the winding portions adjacent to each other in the front-rear direction, that is, the winding portion 23 of the first conductive unit 21 and the winding portion 25 of the second conductive unit 22 have opposite spiral directions with the centers as base points. Similarly, the winding portions 24 and 26 adjacent to each other in the front-rear direction have opposite spiral directions with the centers as base points.

In addition, similarly, in the example shown in FIG. 14, the winding directions of the winding portions 33 and 34 of the first signal output unit 31, which are the winding portions adjacent to each other in the front-rear direction, are opposite to those in the example shown in FIG. 3. Therefore, the winding portions 33 and 35 adjacent to each other in the front-rear direction have opposite spiral directions with the centers as base points. Similarly, the winding portions 34 and 36 adjacent to each other in the front-rear direction have opposite spiral directions with the centers as base points. As described above, in each of the key-side conductive unit 20 and the sensor unit 30, the winding portions adjacent to each other in the front-rear direction have opposite spiral directions with the centers as base points. With this configuration, the directions of the generated magnetic fluxes are opposite not only between the winding portions adjacent to each other in the key arrangement direction but also between the winding portions adjacent to each other in the key longitudinal direction, which further contributes to the prevention of crosstalk.

In each of the above embodiments, it is not essential that each of the conductive units 21 and 22 and the signal output units 31 and 32 is substantially parallel to the key arrangement direction or the key longitudinal direction. Although the conductive unit and the corresponding signal output unit may be inclined in the same direction, it is not essential to be inclined in the same direction.

FIG. 15 is a schematic plan view showing a configuration example of a second modification of the key-side conductive unit 20 and the sensor unit 30. In each of the above embodiments, as shown in FIG. 15, each of the conductive units 21 and 22 (or the conductive units A1 to A4) and the signal output units 31 and 32 (or the signal output units B1 to B4) may be implemented by a coil formed by a single spiral instead of two spirals. In addition, only one of a set of the conductive unit 21 and the signal output unit 31 and a set of the conductive unit 22 and the signal output unit 32 may be configured as a set of coils formed by a single spiral.

The key-side conductive unit is preferably a reactance element, but is not limited to an induction coil, and a conductive member may be used for the key-side conductive unit. For example, as for the key-side conductive unit, metal plates 54 and 55 having conductivity may be provided instead of the conductive units 21 and 22, as shown as a key-side conductive unit 20-2. The metal plates 54 and 55 are made of iron or the like. The metal plates 54 and 55 are plate members substantially parallel to the key pressing surface. When a distance of the metal plates 54 and 55 with respect to the signal output units 31 and 32 changes, a capacitance in the signal output units 31 and 32 changes, and thus a signal having a magnitude corresponding to the distance can be extracted.

Alternatively, one metal plate 56 having conductivity the same as that of the metal plates 54 and 55 may be provided instead of the conductive units 21 and 22, as shown as a key-side conductive unit 20-3. Even when the key-side conductive unit 20-2 or the key-side conductive unit 20-3 is used, coil shapes of the signal output units 31 and 32 may be two spirals or a single spiral.

A parallel movement of the key in the horizontal direction or the vertical direction may be detected from the output of the same (common) signal output unit. For example, in a keyboard in which the entire key can be displaced in parallel to the key arrangement direction, the parallel movement of the key in the key arrangement direction can be detected. Alternatively, in a keyboard in which the entire key can be displaced in parallel to the vertical direction, the parallel movement of the key in the vertical direction can be detected. At this time, in addition to or instead of a detection target illustrated in each of the above embodiments, the parallel movement of the key in the horizontal direction or the vertical direction can be detected.

In each of the examples including the above modifications, the signal output unit that outputs the signal corresponding to the distance from the corresponding key-side conductive unit 20 may be provided such that two or more signal output units correspond to each of the plurality of keys 13, and the number of the signal output units is not limited to two. For example, two or more pairs of the signal output units may be provided, and the displacement may be detected using signals from the respective pairs of signal output units. Alternatively, three signal output units may be arranged, and the middle signal output unit may be dedicated to detecting the stroke position.

The operation detection device of the key of the present disclosure is not necessarily capable of detecting operations of all the keys 13 of the keyboard device 100, and may detect only a part of the keys 13.

An outer shape of each of the spiral portions of the coils C21 and C31 forming the conductive units 21 and 22 and the signal output units 31 and 32 is not limited to a circular shape, and may be an oval shape or a rectangular shape. Although the coils C21 and C31 are of a planar type, the coils C21 and C31 are not necessarily limited to a planar type as long as an arrangement space is allowed.

The present disclosure is not limited to the keyboard device 100, and is also applicable to a pedal, a keyboard for a personal computer, and the like.

In the present embodiment, the ones with “substantially” are not intended to exclude completeness. For example, “substantially parallel” and “substantially circular” are intended to include parallel and circular, respectively.

Although the invention has been described in detail based on the preferred embodiments thereof, the invention is not limited to these specific embodiments, and various embodiments within the scope not departing from the gist of the invention are also included in the invention. Some of the above embodiments may be combined as appropriate.

The present application is based on a Japanese patent application (JP2020-085055A) filed on May 14, 2020, and the contents thereof are incorporated herein as reference.

### REFERENCE SIGNS LIST

13 key
15 circuit board
20 key-side conductive unit
21, 22 conductive unit
31, 32 signal output unit
30 sensor unit
50 control unit
101 operation detection device

1. A key operation detector, comprising:
a conductive unit provided in a key of a keyboard device;
a substrate provided to face the key in a pressing and releasing direction of the key;
a signal output unit including a coil, provided on the substrate, and configured to output a signal corresponding to a position of the conductive unit relative to the signal output unit; and
a detection unit configured to detect a position of the key in the pressing and releasing direction and a displacement of the key in a front-rear direction based on the signal output from the signal output unit.

2. The key operation detector according to claim 1,
wherein the signal output unit includes a pair of signal output units, and
wherein the detection unit detects the position of the key in the pressing and releasing direction based on a sum of signals respectively output from the pair of signal output units, and detects the displacement of the key in the front-rear direction based on a difference between the signals respectively output from the pair of signal output units.

3. The key operation detector according to claim 2,
wherein the pair of signal output units are disposed side by side in the front-rear direction.

4. The key operation detector according to claim 3,
wherein a first signal output unit of the pair of signal output units is disposed to be shifted in a first direction of the front-rear direction with respect to the conductive unit, and
wherein a second signal output unit of the pair of signal output units is disposed to be shifted in a second direction of the front-rear direction opposite to the first direction with respect to the conductive unit.

5. The key operation detector according to claim 1,
wherein the coil includes two spiral portions and connected to each other, and
wherein the two spiral portions have the same spiral direction as each other with a center of each of the two spiral portions as a base point.

6. The key operation detector according to claim 1,
wherein the conductive unit is a metal plate disposed parallel to a surface of the key.

7. The key operation detector according to claim 1,
wherein the conductive unit is a circuit including a coil including two spiral portions connected to each other, and
wherein the two spiral portions in the conductive unit have the same spiral direction as each other with a center of each of the two spiral portions as a base point.

8. The key operation detector according to claim 3,
wherein the signal output unit further includes another pair of signal output units disposed side by side in a key arrangement direction, and
wherein the detection unit detects a displacement of at least one of a yaw direction and a roll direction of the key based on a difference between signals respectively output from another pair of signal output units.

9. A keyboard device comprising:
a plurality of keys; and
a plurality of key operation detectors according to claim 1 respectively disposed corresponding to each of the plurality of keys.

10. The key operation detector according to claim 1,
wherein the signal output unit outputs a signal corresponding to a distance between the conductive unit and signal output unit and an overlapping area of the conductive unit and the signal output unit, and
wherein the detection unit detects the position of the key in the pressing and releasing direction based on the distance between the conductive unit and signal output unit and detects the displacement of the key in the front-rear direction based on the overlapping area of the conductive unit and the signal output unit.

11. A method of detecting a key operation of a key of a keyboard device including (i) a conductive unit provided in the key, (ii) a substrate provided to face the key in a pressing and releasing direction of the key, and (iii) a signal output unit including a coil, provided on the substrate, and configured to output a signal corresponding to a position of the conductive unit relative to the signal output unit,
the method comprising:
acquiring signals output from the signal output unit; and
detecting, based on the acquired signals, a position of the key in the pressing and releasing direction and a displacement of the key in a front-rear direction.
